(19) United States
(12) Patent Application Publication
(10) Pub. No.: US 2015/0034877 A1
(43) Pub. Date: Feb. 5, 2015

(54) ELECTRICALLY CONDUCTIVE RUBBER COMPOSITION, TRANSFER ROLLER, AND IMAGE FORMING APPARATUS

(71) Applicant: SUMITOMO RUBBER INDUSTRIES, LTD., Kobe-shi (JP)

(72) Inventors: Yusuke TANIO, Kobe-shi (JP); Naoyuki SATOYOSHI, Kobe-shi (JP)

(21) Appl. No.: 14/334,960

(22) Filed: Jul. 18, 2014

(30) Foreign Application Priority Data
Aug. 5, 2013 (JP) 2013-162623

(51) Int. Cl. H01B 1/12; G03G 15/16

(52) U.S. Cl. CPC G03G 15/162; H01B 1/125
USPC 252/500; 399/313

(57) ABSTRACT

An electrically conductive rubber composition is provided, which comprises a rubber component including an SBR, an EPDM and an epichlorohydrin rubber, a crosslinking component and an azodicarbonamide foaming agent having an average particle diameter of 3 to 11 μm. The azodicarbonamide foaming agent is blended in a proportion of 0.5 to 8 parts by mass based on 100 parts by mass of the overall rubber component. A transfer roller (1) is produced by extruding the electrically conductive rubber composition into an elongated tubular body, and continuously feeding out the tubular body in the elongated state without cutting the tubular body to continuously pass the tubular body through a microwave crosslinking device and a hot air crosslinking device to continuously foam and crosslink the tubular body.

### TECHNICAL FIELD

The present invention relates to an electrically conductive rubber composition, a transfer roller which is produced by foaming and crosslinking the electrically conductive rubber composition in a tubular shape and is incorporated in an electrophotographic image forming apparatus for use, and an image forming apparatus incorporating the transfer roller.

### BACKGROUND ART

In electrophotographic image forming apparatuses such as a laser printer, an electrostatic copying machine, a plain paper facsimile machine and a copier-printer-facsimile multifunction machine, an image is generally formed on a surface of a sheet such as a paper sheet or a plastic film through the following process steps.

First, a surface of a photoreceptor body having photoelectric conductivity is evenly electrically charged and, in this state, exposed to light, whereby an electrostatic latent image corresponding to an image to be formed on the sheet is formed on the surface of the photoreceptor body (charging step and exposing step).

Then, a toner (minute color particles) preliminarily electrically charged at a predetermined potential is brought into contact with the surface of the photoreceptor body. Thus, the toner selectively adheres to the surface of the photoreceptor body according to the potential pattern of the electrostatic latent image, whereby the electrostatic latent image is developed into a toner image (developing step).

Subsequently, the toner image is transferred onto the surface of the sheet (transfer step), and fixed to the surface of the sheet (fixing step). Thus, the image is formed on the surface of the sheet.

In the transfer step, the toner image formed on the surface of the photoreceptor body may be directly transferred to the surface of the sheet (direct transfer), or may be once transferred to a surface of an image carrier (first transfer step) and then transferred to the surface of the sheet (second transfer step).

In general, a transfer roller is used for directly transferring the toner image from the surface of the photoreceptor body to the surface of the sheet in the transfer step, for transferring the toner image from the surface of the photoreceptor body to the surface of the image carrier in the first transfer step, or for transferring the toner image from the surface of the image carrier to the surface of the sheet in the second transfer step. The transfer roller is formed from an electrically conductive rubber composition and has a predetermined roller resistance.

In the transfer step for the direct transfer, for example, a predetermined transfer voltage is applied between the photoreceptor body and the transfer roller kept in press contact with each other with a predetermined pressing force and, in this state, the sheet is passed between the photoreceptor body and the transfer roller, whereby the toner image formed on the surface of the photoreceptor body is transferred to the surface of the sheet.

Lately, transfer rollers to be incorporated in general-purpose laser printers and the like particularly for use in developing countries tend to be required to have a simplified construction so as to be produced at lower costs possibly by using versatile materials.

To meet the requirement, transfer rollers having a porous structure are widely used. The porous structure requires a reduced amount of a material to reduce material costs, and has a reduced weight to reduce transportation costs. The porous structure imparts the transfer roller with proper flexibility even if a plasticizer is not blended or blended in a reduced amount in the material.

For production of the transfer roller of the porous structure, it is preferred to employ the following continuous production method, for example, in order to improve the productivity of the transfer roller to reduce the production costs of the transfer roller.

That is, an electrically conductive rubber composition containing a rubber component and a foaming component for thermally foaming the rubber component is extruded into an elongated tubular body by means of an extruder, and the extruded tubular body is continuously fed out in the elongated state without cutting thereof to be passed through a continuous crosslinking apparatus including a microwave crosslinking device and a hot air crosslinking device for continuous foaming and crosslinking.

In turn, the foamed and crosslinked tubular body is cut to a predetermined length, and heated by means of an oven or the like for secondary crosslinking. Then, the resulting tubular body is cooled, and polished to a predetermined outer diameter. Thus, the transfer roller is produced.

For the reduction of the material costs and the production costs of the transfer roller, it is preferred to use an expensive ion conductive rubber such as an epichlorohydrin rubber in combination with a crosslinkable rubber as the rubber component for the electrically conductive rubber composition rather than using the expensive ion conductive rubber alone as the rubber component.

A typical example of the crosslinkable rubber is an acrylonitrile butadiene rubber (NBR). In order to further reduce the production costs of the transfer roller to meet the aforementioned requirement, it is more preferred to use a styrene butadiene rubber (SBR) and an ethylene propylene diene rubber (EPDM) in combination as the crosslinkable rubber instead of the NBR (see Patent Literature 1).

The combinational use of the crosslinkable rubber and the ion conductive rubber makes it possible to impart the transfer roller with proper ozone resistance while further reducing the material costs.

That is, the combinational use of the crosslinkable rubber and the ion conductive rubber makes it possible to reduce the proportion of the expensive ion conductive rubber required for imparting the transfer roller with a predetermined roller resistance. In addition, the SBR as the crosslinkable rubber is more versatile and less costly than the NBR, so that the material costs can be further reduced.

However, the SBR is insufficient in resistance to ozone to be generated inside the laser printer or the like, i.e., has poorer ozone resistance. Therefore, the SBR is used in combination with the EPDM.

The EPDM per se does not only have excellent ozone resistance, but also serves to suppress degradation of the SBR due to ozone. This improves the ozone resistance of the transfer roller.

In general, a foaming agent which is thermally decomposed to generate gas and a foaming assisting agent which reduces the decomposition temperature of the foaming agent to promote the decomposition are used in combination as the foaming component.

Particularly, an azodicarbonamide foaming agent (H₂NOCN═NCONH₂, hereinafter sometimes abbreviated as “ADCA”) and an urea foaming assisting agent are widely used in combination as the foaming component (see Patent Literature 2).

### CITATION LIST

### Patent Literature

Patent Literature 1: JP2012-108376A
Patent Literature 2: JP2004-46052A

### SUMMARY OF THE INVENTION

### Problems to be Solved by the Invention

For the reduction of the costs, the foam cell diameter of the transfer roller of the porous structure is preferably as great as possible.

Therefore, it is preferred to use the foaming agent alone as the foaming component without blending the foaming assisting agent which may otherwise reduce the foam cell diameter, or to minimize the proportion of the foaming assisting agent.

However, if a tubular body formed by extruding, foaming and crosslinking an electrically conductive rubber composition containing the foaming assisting agent in a limited proportion is secondarily crosslinked, for example, in an oven and polished within a day after being taken out of the oven for cooling, the polished tubular body is significantly expanded, often failing to maintain its predetermined outer diameter. This reduces the production yield of the transfer roller and hence the productivity.

This problem typically occurs when closed cells are contained at a higher percentage in the porous structure.

That is, gas contained in the closed cells is expanded to be expelled to the outside due to heat applied during the secondary crosslinking and, when the external gas and air are thereafter taken into the closed cells during the cooling, the internal pressures of the closed cells are increased.

In this state, an outermost peripheral portion of the tubular body which is first cooled to be solidified in contact with the outside air and suppresses the expansion of the inside closed cells is polished away in the subsequent step. At this time, the inside closed cells which are not completely cooled to be maintained in a softer state are expanded radially outward of the tubular body due to the internal pressures of the closed cells. Thus, the tubular body is significantly expanded, failing to maintain its predetermined outer diameter.

If the secondarily crosslinked tubular body is cooled for two or more days, for example, the innermost portion of the tubular body can be sufficiently cooled to be solidified, whereby the aforementioned problem can be eliminated. In this case, however, a longer period of time is required for production of a single transfer roller. In addition, a storage space is required for cooling tubular bodies, and intermediate stock is increased. This reduces the production process efficiency, thereby reducing the productivity of the transfer roller.

It is therefore an object of the present invention to provide an electrically conductive rubber composition which ensures that a transfer roller or the like can be produced at higher productivity without significant expansion of a tubular body thereof even if the tubular body is polished within a shorter period of time after the secondary crosslinking and the cooling thereof. It is another object of the present invention to provide a transfer roller formed from the electrically conductive rubber composition and to provide an image forming apparatus incorporating the transfer roller.

### Means for Solving the Problems

The present invention provides an electrically conductive rubber composition which can be foamed and crosslinked by means of a continuous crosslinking apparatus including a microwave crosslinking device and a hot air crosslinking device, the electrically conductive rubber composition comprising a rubber component including at least an SBR, an EPDM and an epichlorohydrin rubber, a crosslinking component for crosslinking the rubber component, and a foaming component for foaming the rubber component, wherein the foaming component comprises an ADCA foaming agent having an average particle diameter of not less than 3 μm and not greater than 11 μm (hereinafter sometimes referred to as “smaller-diameter ADCA”) in a proportion of not less than 0.5 parts by mass and not greater than 8 parts by mass based on 100 parts by mass of the overall rubber component.

The present invention also provides a transfer roller formed from the inventive electrically conductive rubber composition.

The present invention further provides an image forming apparatus incorporating the inventive transfer roller.

According to the present invention, the SBR and the EPDM are used instead of the NBR as the crosslinkable rubber in combination with the epichlorohydrin rubber. This makes it possible to impart the transfer roller with proper ozone resistance while suppressing the material costs.

According to the present invention, the smaller-diameter ADCA foaming agent having a smaller average particle diameter (i.e., not less than 3 μm and not greater than 11 μm) is used, whereby the percentage of closed cells present in a porous body resulting from the foaming and the crosslinking of the rubber component can be reduced as compared with the prior art.

That is, the smaller-diameter ADCA foaming agent having an average particle diameter of not greater than 11 μm has a higher decomposition speed and a higher foaming speed as compared with a common greater-diameter ADCA foaming agent having an average particle diameter of greater than 11 μm.

Therefore, the electrically conductive rubber composition containing the smaller-diameter ADCA foaming agent is rapidly foamed by heat applied in the extruding step and the subsequent foaming and crosslinking step, and open cells communicating with each other are liable to be formed due to the rapid foaming. As a result, the percentage of the closed cells can be reduced.

The open cells also communicate with the outside air, so that gas and air are let in and out of the open cells according to a temperature change. Therefore, the internal pressures of the cells are not increased even after the secondary crosslinking step.

This suppresses the expansion of the tubular body which may otherwise occur due to the increase in the internal pressures of the closed cells after the polishing. Even if the tubular body is polished within a shorter period of time, e.g., within a day, after the tubular body is secondarily crosslinked in an oven and taken out of the oven, the tubular body can maintain its predetermined outer diameter. This improves the productivity of the transfer roller.

In the present invention, the average particle diameter of the smaller-diameter ADCA foaming agent is limited to not less than 3 μm. This is because minute ADCA particles having an average particle diameter less than this range are excessively reactive and, therefore, are likely to decompose in response to a slight temperature change. Accordingly, the minute ADCA particles are not suitable as the foaming agent which is required not to decompose at least when being kneaded together with the rubber component.

For this reason, the minute ADCA particles are industrially unavailable as a product (foaming agent).

In the present invention, the average particle diameters of the smaller-diameter ADCA foaming agent and other ADCA foaming agents are determined by a centrifugal precipitation method.

In the present invention, the proportion of the smaller-diameter ADCA foaming agent is limited to the aforementioned range for the following reasons:

If the proportion of the smaller-diameter ADCA foaming agent is less than the aforementioned range, it will be impossible to sufficiently foam the electrically conductive rubber composition. This results in excessively high rubber hardness, making it impossible to impart the transfer roller with proper flexibility.

If the foaming is insufficient, it will be impossible to provide the effect of reducing the use amount of the material for the reduction of the material costs, and the effect of reducing the weight of the transfer roller for the reduction of the transportation costs.

If the proportion of the smaller-diameter ADCA foaming agent is greater than the aforementioned range, the electrically conductive rubber composition is liable to be excessively foamed to provide an excessively low rubber hardness, failing to impart the transfer roller with proper strength.

Where the proportion of the smaller-diameter ADCA foaming agent is not less than 0.5 parts by mass and not greater than 8 parts by mass based on 100 parts by mass of the overall rubber component, in contrast, the transfer roller is imparted with proper rubber hardness to eliminate the aforementioned problems.

The rubber component preferably further includes at least one polar rubber selected from the group consisting of an NBR, a chloroprene rubber (CR), a butadiene rubber (BR) and an acryl rubber (ACM).

Thus, the roller resistance of the transfer roller can be finely adjusted.

The inventive transfer roller is preferably produced by extruding the inventive electrically conductive rubber composition into a tubular body, and continuously foaming and crosslinking the tubular body by means of a continuous crosslinking apparatus including a microwave crosslinking device and a hot air crosslinking device.

Thus, the productivity is improved as described above to further reduce the production costs of the transfer roller.

### Effects of the Invention

According to the present invention, the electrically conductive rubber composition can be provided, which ensures that a transfer roller or the like can be produced at higher productivity without significant expansion of a tubular body thereof even if the tubular body is polished in a shorter period of time after the secondary crosslinking and the cooling thereof. According to the present invention, the transfer roller formed from the electrically conductive rubber composition, and the image forming apparatus incorporating the transfer roller are also provided.

### BRIEF DESCRIPTION OF THE DRAWINGS

FIG. 1 is a perspective view illustrating an exemplary transfer roller according to one embodiment of the present invention.

FIG. 2 is a block diagram schematically illustrating a continuous crosslinking apparatus to be used for production of the inventive transfer roller.

FIG. 3 is a diagram for explaining how to measure the roller resistance of the transfer roller.

### EMBODIMENTS OF THE INVENTION

<<Electrically Conductive Rubber Composition>>

The present invention provides an electrically conductive rubber composition which can be foamed and crosslinked by means of a continuous crosslinking apparatus including a microwave crosslinking device and a hot air crosslinking device. The electrically conductive rubber composition comprises a rubber component including at least an SBR, an EPDM and an epichlorohydrin rubber, a crosslinking component for crosslinking the rubber component, and a foaming component for foaming the rubber component. The foaming component comprises a smaller-diameter ADCA foaming agent having an average particle diameter of not less than 3 μm and not greater than 11 μm in a proportion of not less than 0.5 parts by mass and not greater than 8 parts by mass based on 100 parts by mass of the overall rubber component.

<SBR>

Usable as the SBR are various SBRs synthesized by copolymerizing styrene and 1,3-butadiene by an emulsion polymerization method, a solution polymerization method and other various polymerization methods. The SBRs include those of an oil-extension type having flexibility controlled by addition of an extension oil, and those of a non-oil-extension type containing no extension oil. Either type of SBRs is usable.

According to the styrene content, the SBRs are classified into a higher styrene content type, an intermediate styrene content type and a lower styrene content type, and any of these types of SBRs is usable. Physical properties of the transfer roller can be controlled by changing the styrene content and the crosslinking degree.

These SBRs may be used either alone or in combination.

Where the rubber component includes only the three types of rubbers including the SBR, the EPDM and the epichlorohydrin rubber and includes no polar rubber, the proportion of the SBR to be blended is preferably not less than 40 parts by mass and not greater than 90 parts by mass, particularly preferably not less than 60 parts by mass and not greater than 80 parts by mass, based on 100 parts by mass of the overall rubber component. Where the rubber component includes a polar rubber, the proportion of the SBR is preferably not less than 15 parts by mass and not greater than 50 parts by mass, more preferably not less than 20 parts by mass, particularly preferably not less than 30 parts by mass, based on 100 parts by mass of the overall rubber component depending on the proportion of the polar rubber.

If the proportion of the SBR is less than the aforementioned range, the advantageous features of the SBR described above, i.e., higher versatility and lower costs, cannot be ensured.

If the proportion of the SBR is greater than the aforementioned range, the proportion of the EPDM is relatively reduced, making it impossible to impart the transfer roller with excellent ozone resistance. Further, the proportion of the epichlorohydrin rubber is also relatively reduced, making it impossible to impart the transfer roller with proper ion conductivity.

Where an oil-extension type SBR is used, the proportion of the SBR described above is defined as the solid proportion of the SBR contained in the oil-extension type SBR.

### <EPDM>

Usable as the EPDM are various EPDMs each prepared by introducing double bonds into a main chain thereof by employing a small amount of a third ingredient (diene) in addition to ethylene and propylene. A variety of EPDM products containing different types of third ingredients in different amounts are commercially available. Typical examples of the third ingredients include ethylidene norbornene (ENB), 1,4-hexadiene (1,4-HD) and dicyclopentadiene (DCP). A Ziegler catalyst is typically used as a polymerization catalyst.

The proportion of the EPDM to be blended is preferably not less than 5 parts by mass and not greater than 40 parts by mass, particularly preferably not greater than 20 parts by mass, based on 100 parts by mass of the overall rubber component.

If the proportion of the EPDM is less than the aforementioned range, it will be impossible to impart the transfer roller with excellent ozone resistance.

If the proportion of the EPDM is greater than the aforementioned range, on the other hand, the proportion of the SBR is relatively reduced, so that the advantageous features of the SBR, i.e., higher versatility and lower costs, cannot be ensured. Further, the proportion of the epichlorohydrin rubber is relatively reduced, making it impossible to impart the transfer roller with proper ion conductivity.

<Epichlorohydrin Rubber>

Examples of the epichlorohydrin rubber include epichlorohydrin homopolymers, epichlorohydrin-ethylene oxide bipolymers (ECO), epichlorohydrin-propylene oxide bipolymers, epichlorohydrin-allyl glycidyl ether bipolymers, epichlorohydrin-ethylene oxide-allyl glycidyl ether terpolymers (GECO), epichlorohydrin-propylene oxide-allyl glycidyl ether terpolymers and epichlorohydrin-ethylene oxide-propylene oxide-allyl glycidyl ether quaterpolymers, which may be used either alone or in combination.

Of the aforementioned examples, the ethylene oxide-containing copolymers, particularly the ECO and/or the GECO are preferred as the epichlorohydrin rubber.

These copolymers preferably each have an ethylene oxide content of not less than 30 mol % and not greater than 80 mol %, particularly preferably not less than 50 mol %.

Ethylene oxide functions to reduce the roller resistance of the transfer roller. If the ethylene oxide content is less than the aforementioned range, however, it will be impossible to sufficiently provide the roller resistance reducing function and hence to sufficiently reduce the roller resistance of the transfer roller.

If the ethylene oxide content is greater than the aforementioned range, on the other hand, ethylene oxide is liable to be crystallized, whereby the segment motion of molecular chains is hindered to adversely increase the roller resistance of the transfer roller. Further, the transfer roller is liable to have a higher hardness after the crosslinking, and the electrically conductive rubber composition is liable to have a higher viscosity when being heat-melted before the crosslinking.

The ECO has an epichlorohydrin content that is a balance obtained by subtracting the ethylene oxide content from the total. That is, the epichlorohydrin content is preferably not less than 20 mol % and not greater than 70 mol %, particularly preferably not greater than 50 mol %.

The GECO preferably has an allyl glycidyl ether content of not less than 0.5 mol % and not greater than 10 mol %, particularly preferably not less than 2 mol % and not greater than 5 mol %.

Allyl glycidyl ether per se functions as side chains of the copolymer to provide a free volume, whereby the crystallization of ethylene oxide is suppressed to reduce the roller resistance of the transfer roller. However, if the allyl glycidyl ether content is less than the aforementioned range, it will be impossible to provide the roller resistance reducing function and hence to sufficiently reduce the roller resistance of the transfer roller.

Allyl glycidyl ether also functions as crosslinking sites during the crosslinking of the GECO. Therefore, if the allyl glycidyl ether content is greater than the aforementioned range, the crosslinking density of the GECO is increased, whereby the segment motion of molecular chains is hindered. This may adversely increase the roller resistance of the transfer roller. Further, the transfer roller is liable to suffer from reduction in tensile strength, fatigue resistance and flexural resistance.

The GECO has an epichlorohydrin content that is a balance obtained by subtracting the ethylene oxide content and the allyl glycidyl ether content from the total. That is, the epichlorohydrin content is preferably not less than 10 mol % and not greater than 69.5 mol %, particularly preferably not less than 19.5 mol % and not greater than 60 mol %.

Examples of the GECO include copolymers of the three comonomers described above in a narrow sense, as well as known modification products obtained by modifying an epichlorohydrin-ethylene oxide copolymer (ECO) with allyl glycidyl ether. In the present invention, any of these modification products may be used as the GECO.

The proportion of the epichlorohydrin rubber to be blended is preferably not less than 5 parts by mass and not greater than 40 parts by mass, particularly preferably not less than 10 parts by mass and not greater than 30 parts by mass, based on 100 parts by mass of the overall rubber component.

If the proportion of the epichlorohydrin rubber is less than the aforementioned range, it will be impossible to impart the transfer roller with proper ion conductivity.

If the proportion of the epichlorohydrin rubber is greater than the aforementioned range, on the other hand, the proportion of the SBR is relatively reduced. Therefore, the advantageous features of the SBR, i.e., higher versatility and lower costs, cannot be ensured. Further, the proportion of the EPDM is also relatively reduced, making it impossible to impart the transfer roller with excellent ozone resistance.

### <Polar Rubber>

As described above, the roller resistance of the transfer roller can be finely controlled by blending the polar rubber. Further, a more uniform porous structure free from foaming unevenness can be provided.

Examples of the polar rubber include an NBR, a CR, a BR and an ACM, which may be used either alone or in combination. Particularly, the NBR and/or the CR are preferred.

The NBR is classified in a lower acrylonitrile content type, an intermediate acrylonitrile content type, an intermediate to higher acrylonitrile content type, a higher acrylonitrile content type or a very high acrylonitrile content type depending on the acrylonitrile content. Any of these types of NBRs is usable.

The CR is synthesized, for example, by polymerizing chloroprene by an emulsion polymerization method. The CR is classified in a sulfur modification type or a non-sulfur-modification type depending on the type of a molecular weight adjusting agent to be used for the emulsion polymerization. The CR is also classified in a lower crystallization speed type, an intermediate crystallization speed type or a higher crystallization speed type depending on the crystallization speed. Any of these types of CRs is usable.

The proportion of the polar rubber to be blended may be properly determined according to the target roller resistance of the transfer roller. The proportion of the polar rubber is preferably not less than 5 parts by mass and not greater than 40 parts by mass, particularly preferably not less than 20 parts by mass, based on 100 parts by mass of the overall rubber component.

If the proportion of the polar rubber is less than the aforementioned range, it will be impossible to sufficiently provide the effect of finely controlling the roller resistance of the transfer roller and the effect of preventing the uneven foaming by the blending of the polar rubber.

If the proportion of the polar rubber is greater than the aforementioned range, the proportion of the SBR is relatively reduced and, therefore, the advantageous features of the SBR, i.e., higher versatility and lower costs, cannot be ensured. Further, the proportion of the EPDM is relatively reduced, making it impossible to impart the transfer roller with excellent ozone resistance. In addition, the proportion of the epichlorohydrin rubber is relatively reduced, making it impossible to impart the transfer roller with proper ion conductivity.

<Foaming Component>

### (Foaming Agent)

In the present invention, as described above, the smaller-diameter ADCA foaming agent having an average particle diameter of not less than 3 μm and not greater than 11 μm is used as the foaming agent of the foaming component which is thermally decomposed for the generation of gas.

Thus, the percentage of closed cells present in a porous body resulting from the foaming and the crosslinking can be reduced as compared with the prior art.

That is, the smaller-diameter ADCA foaming agent has a higher decomposition speed and a higher foaming speed as compared with a common greater-diameter ADCA foaming agent having an average particle diameter of greater than 11 μm.

Therefore, the electrically conductive rubber composition containing the smaller-diameter ADCA foaming agent is rapidly foamed by heat applied in the extruding step and the subsequent foaming and crosslinking step as described above, and open cells communicating with each other are liable to be formed due to the rapid foaming. As a result, the percentage of the closed cells can be reduced.

The open cells also communicate with the outside air, so that gas and air are let in and out of the open cells according to a temperature change. Therefore, the internal pressures of the cells are not increased even after the secondary crosslinking step.

This suppresses the expansion of the tubular body which may otherwise occur due to the increase in the internal pressures of the closed cells after the polishing as described above. Even if the tubular body is polished within a shorter period of time, e.g., within a day, after the tubular body is secondarily crosslinked in an oven and taken out of the oven, the tubular body can maintain its predetermined outer diameter. This improves the productivity of the transfer roller.

In the present invention, the average particle diameter of the smaller-diameter ADCA foaming agent is limited to not less than 3 μm. This is because minute ADCA particles having an average particle diameter less than this range are excessively reactive and, therefore, are likely to decompose in response to a slight temperature change. Accordingly, the minute ADCA particles are not suitable as the foaming agent which is required not to decompose at least when being kneaded together with the rubber component.

For this reason, the minute ADCA particles are industrially unavailable as a product (foaming agent).

Specific examples of the smaller-diameter ADCA foaming agent having an average particle diameter of not less than 3 μm and not greater than 11 μm include CELLMIC (registered trade name) CE (having an average particle diameter of 6 to 7 μm), CELLMIC C-22 (having an average particle diameter of 4 to 6 μm), CELLMIC C-1 (having an average particle diameter of 8 to 11 μm) and CELLMIC C-2 (having an average particle diameter of 3 to 5 μm) available from Sankyo Kasei Co., Ltd. These may be used either alone or in combination.

The proportion of the smaller-diameter ADCA foaming agent to be blended is limited to not less than 0.5 parts by mass and not greater than 8 parts by mass based on 100 parts by mass of the overall rubber component for the following reasons:

If the proportion of the smaller-diameter ADCA foaming agent is less than the aforementioned range, it will be impossible to sufficiently foam the electrically conductive rubber composition. This results in excessively high rubber hardness, making it impossible to impart the transfer roller with proper flexibility.

If the foaming is insufficient, it will be impossible to provide the effect of reducing the use amount of the material for the reduction of the material costs, and the effect of reducing the weight of the transfer roller for the reduction of the transportation costs.

If the proportion of the smaller-diameter ADCA foaming agent is greater than the aforementioned range, the electrically conductive rubber composition is liable to be excessively foamed to provide an excessively low rubber hardness, failing to impart the transfer roller with proper strength.

Where the proportion of the smaller-diameter ADCA foaming agent is not less than 0.5 parts by mass and not greater than 8 parts by mass based on 100 parts by mass of the overall rubber component, in contrast, the transfer roller is imparted with proper rubber hardness to eliminate the aforementioned problems.

That is, the transfer roller can be kept in contact with a photoreceptor body with a proper nip pressure and a proper nip width without early abrasion thereof and without any damage to the photoreceptor body. Thus, the reduction in toner transfer efficiency can be prevented.

Other types of foaming agents may be used in combination with the smaller-diameter ADCA foaming agent as long as the aforementioned effects provided by the use of the smaller-diameter ADCA foaming agent are not impaired. Examples of such forming agents include common ADCA foaming agents having an average particle diameter of greater than 11 μm.

For further improvement of the effect of the use of the smaller-diameter ADCA foaming agent, however, the smaller-diameter ADCA foaming agent is preferably used alone as the foaming agent.

### (Foaming Assisting Agent)

In order to increase the foam cell diameter as much as possible, as described above, the foaming agent including at least the aforementioned smaller-diameter ADCA foaming agent is preferably used alone as the foaming component. If a foaming assisting agent is blended, the proportion of the foaming assisting agent is preferably minimized.

Examples of the foaming assisting agent include urea foaming assisting agents which function to reduce the decomposition temperature of ADCA. Particularly, urea (H₂NCONH₂) is preferably used.

The proportion of the foaming assisting agent to be blended is preferably not greater than 5 parts by mass, particularly preferably not greater than 3 parts by mass, based on 100 parts by mass of the overall rubber component.

If the proportion of the foaming assisting agent is greater than the aforementioned range, the decomposition temperature of the ADCA foaming agent is reduced as described above. Therefore, particles of the ADCA foaming agent are substantially simultaneously evenly decomposed to foam the entire tubular body in a shorter period of time from the start of heating. Thus, expansion power of adjacent foam cells being expanded by the foaming suppresses the expansion of the adjacent cells. This reduces the cell diameters of the foam cells in the porous structure.

The lower limit of the proportion of the foaming assisting agent is 0 part by mass. In order to increase the foam cell diameter, it is most preferred not to blend the foaming assisting agent as the foaming component. For improvement of the uniformity of the foam cell diameter, however, the foaming assisting agent may be blended in a small amount within the aforementioned range.

### <Crosslinking Component>

The crosslinking component for crosslinking the rubber component includes a crosslinking agent, an accelerating agent and the like.

Examples of the crosslinking agent include a sulfur crosslinking agent, a thiourea crosslinking agent, a triazine derivative crosslinking agent, a peroxide crosslinking agent and various monomers, which may be used either alone or in combination. Among these crosslinking agents, the sulfur crosslinking agent is preferred.

Examples of the sulfur crosslinking agent include sulfur powder and organic sulfur-containing compounds. Examples of the organic sulfur-containing compounds include tetramethylthiuram disulfide and N,N-dithiobismorpholine. Sulfur such as the sulfur powder is particularly preferred.

The proportion of the sulfur to be blended is preferably not less than 0.2 parts by mass and not greater than 5 parts by mass, particularly preferably not less than 1 part by mass and not greater than 3 parts by mass, based on 100 parts by mass of the overall rubber component.

If the proportion of the sulfur is less than the aforementioned range, the electrically conductive rubber composition is liable to have a lower crosslinking speed as a whole, requiring a longer period of time for the crosslinking to reduce the productivity of the transfer roller. If the proportion of the sulfur is greater than the aforementioned range, the transfer roller is liable to have a higher compression set after the crosslinking, or an excess amount of the sulfur is liable to bloom on an outer peripheral surface of the transfer roller.

Examples of the accelerating agent include inorganic accelerating agents such as lime, magnesia (MgO) and litharge (PbO), and organic accelerating agents, which may be used either alone or in combination.

Examples of the organic accelerating agents include: guanidine accelerating agents such as di-o-tolylguanidine, 1,3-diphenylguanidine, 1-o-tolylbiguanide and a di-o-tolylguanidine salt of dicatechol borate; thiazole accelerating agents such as 2-mercaptobenzothiazole and di-2-benzothiazyl disulfide; sulfenamide accelerating agents such as N-cyclohexyl-2-benzothiazylsulfenamide; thiuram accelerating agents such as tetramethylthiuram monosulfide, tetramethylthiuram disulfide, tetraethylthiuram disulfide and dipentamethylenethiuram tetrasulfide; and thiourea accelerating agents, which may be used either alone or in combination.

According to the type of the crosslinking agent to be used, at least one optimum accelerating agent is selected from the various accelerating agents for use in combination with the crosslinking agent. For use in combination with the sulfur crosslinking agent, the accelerating agent is preferably selected from the thiuram accelerating agents and the thiazole accelerating agents.

Different types of accelerating agents have different crosslinking accelerating mechanisms and, therefore, are preferably used in combination. The proportions of the accelerating agents to be used in combination may be properly determined, and are preferably not less than 0.1 part by mass and not greater than 5 parts by mass, particularly preferably not less than 0.5 parts by mass and not greater than 2 parts by mass, based on 100 parts by mass of the overall rubber component.

The crosslinking component may further include an acceleration assisting agent.

Examples of the acceleration assisting agent include: metal compounds such as zinc white; fatty acids such as stearic acid, oleic acid and cotton seed fatty acids; and other conventionally known acceleration assisting agents, which may be used either alone or in combination.

The proportion of the acceleration assisting agent to be blended may be properly determined according to the types and combination of the rubbers of the rubber component, and the types and combination of the crosslinking agent and the accelerating agent.

<Other Ingredients>

As required, various additives may be added to the electrically conductive rubber composition. Examples of the additives include an acid accepting agent, a plasticizing agent, a processing aid, a degradation preventing agent, a filler, an anti-scorching agent, a UV absorbing agent, a lubricant, a pigment, an anti-static agent, a flame retarder, a neutralizing agent, a nucleating agent, a co-crosslinking agent and the like.

In the presence of the acid accepting agent, chlorine-containing gases generated from the epichlorohydrin rubber during the crosslinking of the rubber component are prevented from remaining in the transfer roller. Thus, the acid accepting agent functions to prevent the inhibition of the crosslinking and the contamination of the photoreceptor body, which may otherwise be caused by the chlorine-containing gases.

Any of various substances serving as acid acceptors may be used as the acid accepting agent. Preferred examples of the acid accepting agent include hydrotalcites and Magsarat which are excellent in dispersibility. Particularly, the hydrotalcites are preferred.

Where the hydrotalcites are used in combination with magnesium oxide or potassium oxide, a higher acid accepting effect can be provided, thereby more reliably preventing the contamination of the photoreceptor body.

The proportion of the acid accepting agent to be blended is preferably not less than 0.2 parts by mass and not greater than 5 parts by mass, particularly preferably not less than 0.5 parts by mass and not greater than 2 parts by mass, based on 100 parts by mass of the overall rubber component.

If the proportion of the acid accepting agent is less than the aforementioned range, it will be impossible to sufficiently provide the effect of the blending of the acid accepting agent. If the proportion of the acid accepting agent is greater than the aforementioned range, the transfer roller is liable to have an increased hardness after the crosslinking.

Examples of the plasticizing agent include plasticizers such as dibutyl phthalate (DBP), dioctyl phthalate (DOP) and tricresyl phosphate, and waxes such as polar waxes. Examples of the processing aid include fatty acids such as stearic acid.

The proportion of the plasticizing agent and/or the processing aid to be blended is preferably not greater than 5 parts by mass based on 100 parts by mass of the overall rubber component. This prevents the contamination of the photoreceptor body, for example, when the transfer roller is mounted in an image forming apparatus or when the image forming apparatus is operated. For this purpose, it is particularly preferred to use any of the polar waxes as the plasticizing component.

Examples of the degradation preventing agent include various anti-aging agents and anti-oxidants.

The anti-oxidants serve to reduce the environmental dependence of the roller resistance of the transfer roller and to suppress the increase in roller resistance during continuous energization of the transfer roller. Examples of the anti-oxidants include nickel diethyldithiocarbamate (NOCRAC (registered trade name) NEC-P available from Ouchi Shinko Chemical Industrial Co., Ltd.) and nickel dibutyldithiocarbamate (NOCRAC NBC available from Ouchi Shinko Chemical Industrial Co., Ltd.)

Examples of the filler include zinc oxide, silica, carbon, carbon black, clay, talc, calcium carbonate, magnesium carbonate and aluminum hydroxide, which may be used either alone or in combination.

The mechanical strength and the like of the transfer roller can be improved by blending the filler.

Where electrically conductive carbon black is used as the filler, it is possible to improve the microwave absorbing efficiency of the entire electrically conductive rubber composition and to impart the transfer roller with electron conductivity.

A preferred example of the electrically conductive carbon black is HAF. The HAF is particularly excellent in microwave absorbing efficiency, and can be evenly dispersed in the electrically conductive rubber composition to impart the transfer roller with more uniform electron conductivity.

The proportion of the electrically conductive carbon black to be blended is preferably not less than 5 parts by mass and not greater than 30 parts by mass, more preferably not greater than 25 parts by mass, particularly preferably not greater than 20 parts by mass, based on 100 parts by mass of the overall rubber component.

Examples of the anti-scorching agent include N-cyclohexylthiophthalimide, phthalic anhydride, N-nitrosodiphenylamine and 2,4-diphenyl-4-metyl-1-pentene, which may be used either alone or in combination. Particularly, N-cyclohexylthiophthalimide is preferred.

The proportion of the anti-scorching agent to be blended is preferably not less than 0.1 part by mass and not greater than 5 parts by mass, particularly preferably not greater than 1 part by mass, based on 100 parts by mass of the overall rubber component.

The co-crosslinking agent serves to crosslink itself as well as the rubber component to increase the overall molecular weight.

Examples of the co-crosslinking agent include ethylenically unsaturated monomers typified by methacrylic esters, metal salts of methacrylic acid and acrylic acid, polyfunctional polymers utilizing functional groups of 1,2-polybutadienes, and dioximes, which may be used either alone or in combination.

Examples of the ethylenically unsaturated monomers include:

(a) monocarboxylic acids such as acrylic acid, methacrylic acid and crotonic acid;
(b) dicarboxylic acids such as maleic acid, fumaric acid and itaconic acid;
(c) esters and anhydrides of the unsaturated carboxylic acids (a) and (b);
(d) metal salts of the monomers (a) to (c);
(e) aliphatic conjugated dienes such as 1,3-butadiene, isoprene and 2-chloro-1,3-butadiene;
(f) aromatic vinyl compounds such as styrene, α-methylstyrene, vinyltoluene, ethylvinylbenzene and divinylbenzene;
(g) vinyl compounds such as triallyl isocyanurate, triallyl cyanurate and vinylpyridine each having a hetero ring; and
(h) cyanovinyl compounds such as (meth)acrylonitrile and α-chloroacrylonitrile, acrolein, formyl sterol, vinyl methyl ketone, vinyl ethyl ketone and vinyl butyl ketone. These ethylenically unsaturated monomers may be used either alone or in combination.

Monocarboxylic acid esters are preferred as the esters (c) of the unsaturated carboxylic acids.

Specific examples of the monocarboxylic acid esters include:

alkyl (meth)acrylates such as methyl (meth)acrylate, ethyl (meth)acrylate, n-propyl (meth)acrylate, i-propyl (meth)acrylate, n-butyl (meth)acrylate, i-butyl (meth)acrylate, n-pentyl (meth)acrylate, i-pentyl (meth)acrylate, n-hexyl (meth)acrylate, cyclohexyl (meth)acrylate, 2-ethylhexyl (meth)acrylate, octyl (meth)acrylate, i-nonyl (meth)acrylate, tert-butylcyclohexyl (meth)acrylate, decyl (meth)acrylate, dodecyl (meth)acrylate, hydroxymethyl (meth)acrylate and hydroxyethyl (meth)acrylate;

aminoalkyl (meth)acrylates such as aminoethyl (meth)acrylate, dimethylaminoethyl (meth)acrylate and butylaminoethyl (meth)acrylate;

(meth)acrylates such as benzyl (meth)acrylate, benzoyl (meth)acrylate and aryl (meth)acrylates each having an aromatic ring;

(meth)acrylates such as glycidyl (meth)acrylate, methaglycidyl (meth)acrylate and epoxycyclohexyl (meth)acrylate each having an epoxy group;

(meth)acrylates such as N-methylol (meth)acrylamide, γ-(meth)acryloxypropyltrimethoxysilane and tetrahydrofurfuryl methacrylate each having a functional group; and

polyfunctional (meth)acrylates such as ethylene glycol di(meth)acrylate, trimethylolpropane tri(meth)acrylate, ethylene dimethacrylate (EDMA), polyethylene glycol dimethacrylate and isobutylene ethylene dimethacrylate. These monocarboxylic acid esters may be used either alone or in combination.

The inventive electrically conductive rubber composition containing the ingredients described above can be prepared in a conventional manner. First, the rubbers for the rubber component are blended in the predetermined proportions, and the resulting rubber component is simply kneaded. After additives other than the foaming component and the crosslinking component are added to and kneaded with the rubber component, the foaming component and the crosslinking component are finally added to and further kneaded with the resulting mixture. Thus, the electrically conductive rubber composition is provided. A kneader, a Banbury mixer, an extruder or the like, for example, is usable for the kneading.

<<Transfer Roller>>

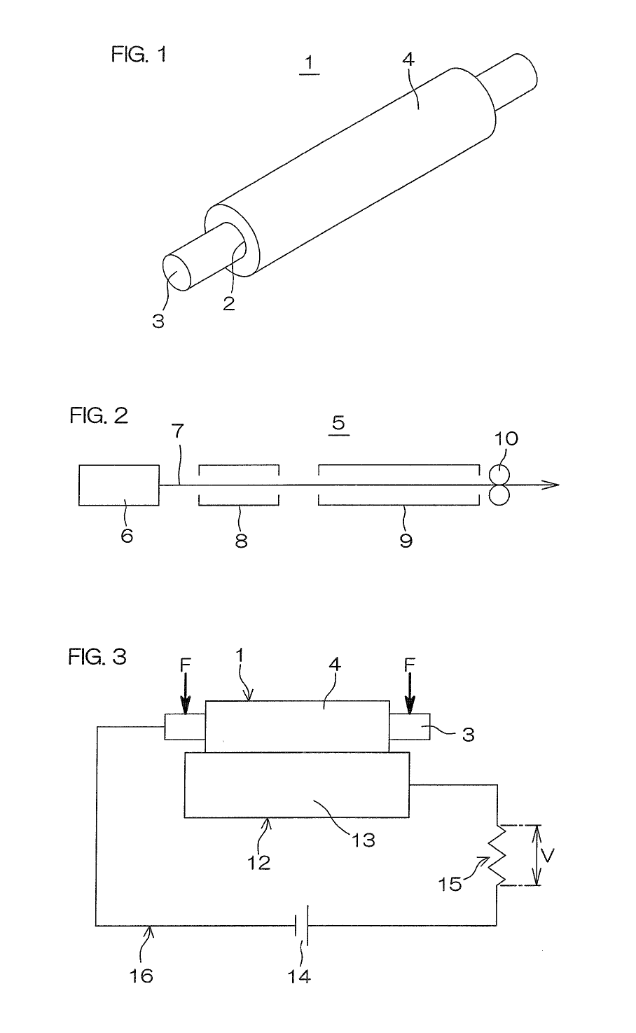

FIG. 1 is a perspective view illustrating an exemplary transfer roller according to one embodiment of the present invention.

Referring to FIG. 1, the transfer roller 1 according to this embodiment is a tubular body of a single layer structure formed from the inventive electrically conductive rubber composition and comprises an outer peripheral surface 4, and a shaft 3 is inserted through and fixed to a center through-hole 2 of the transfer roller 1.

The shaft 3 is a unitary member made of a metal such as aluminum, an aluminum alloy or a stainless steel.

The shaft 3 is electrically connected to and mechanically fixed to the transfer roller 1, for example, via an electrically conductive adhesive agent. Alternatively, a shaft having an outer diameter greater than the inner diameter of the through-hole 2 is used as the shaft 3, and press-inserted into the through-hole 2 to be electrically connected to and mechanically fixed to the transfer roller 1. Thus, the shaft 3 and the transfer roller 1 are unitarily rotatable.

As described above, the transfer roller 1 is preferably produced by extruding the inventive electrically conductive rubber composition into an elongated tubular body by means of an extruder, and continuously feeding out the extruded tubular body in the elongated state without cutting the tubular body to continuously pass the tubular body through the continuous crosslinking apparatus including the microwave crosslinking device and the hot air crosslinking device to continuously foam and crosslink the tubular body.

FIG. 2 is a block diagram for briefly explaining an example of the continuous crosslinking apparatus.

Referring to FIGS. 1 and 2, the continuous crosslinking apparatus 5 according to this embodiment includes a microwave crosslinking device 8, a hot air crosslinking device 9 and a take-up device 10 provided in this order on a continuous transportation path along which an elongated tubular body 7 formed by continuously extruding the inventive electrically conductive rubber composition by an extruder 6 for the transfer roller 1 is continuously transported in the elongated state without cutting by a conveyor (not shown) or the like. The take-up device 10 is adapted to take up the tubular body 7 at a predetermined speed.

First, the ingredients described above are mixed and kneaded together. The resulting electrically conductive rubber composition is formed into a ribbon shape, and continuously fed into the extruder 6 to be continuously extruded into the elongated tubular body 7 by operating the extruder 6.

In turn, the extruded tubular body 7 is continuously transported at the predetermined speed by the conveyor and the take-up device 10 to be passed through the microwave crosslinking device 8 of the continuous crosslinking apparatus 5, whereby the electrically conductive rubber composition forming the tubular body 7 is crosslinked to a certain crosslinking degree by irradiation with microwaves. Further, the inside of the microwave crosslinking device 8 is heated to a predetermined temperature, whereby the electrically conductive rubber composition is further crosslinked, and foamed by decomposition of the foaming agent.

Subsequently, the tubular body 7 is further transported to be passed through the hot air crosslinking device 9, whereby hot air is applied to the tubular body 7. Thus, the electrically conductive rubber composition is further foamed by the decomposition of the foaming agent, and crosslinked to a predetermined crosslinking degree.

Then, the tubular body 7 is cooled. Thus, a foaming and crosslinking step is completed, in which the tubular body 7 is foamed and crosslinked.

The continuous crosslinking apparatus 5 is detailed, for example, in Patent Literatures 1 and 2 described above.

The tubular body 7 formed from the electrically conductive rubber composition as having a crosslinking degree and a foaming degree each controlled at a desired level can be continuously provided by properly setting the transportation speed of the tubular body 7, the microwave irradiation dose of the microwave crosslinking device 8, the setting temperature and the length of the hot air crosslinking device 9, and the like (the microwave crosslinking device 8 and the hot air crosslinking device 9 may be each divided into a plurality of sections, and microwave irradiation doses and setting temperatures at these sections may be changed stepwise).

The tubular body 7 being transported may be twisted so that the microwave irradiation dose and the heating degree can be made more uniform throughout the entire tubular body 7 to make the crosslinking degree and the foaming degree of the tubular body 7 more uniform.

The continuous crosslinking with the use of the continuous crosslinking apparatus 5 improves the productivity of the tubular body 7, and further reduces the production costs of the transfer roller 1.

Thereafter, the tubular body 7 thus foamed and crosslinked is cut to a predetermined length, and heated in an oven or the like for secondary crosslinking. Then, the resulting tubular body is cooled, and polished to a predetermined outer diameter. Thus, the inventive transfer roller 1 is produced.

According to the present invention, as described above, the percentage of the closed cells is reduced by the effects of the use of the smaller-diameter ADCA foaming agent, and the internal pressures of the closed cells are not increased even after the secondary crosslinking. This suppresses the expansion of the tubular body after the polishing. Even if the tubular body is polished within a shorter period of time, e.g., within a day, after being secondarily crosslinked in the oven and taken out of the oven, the tubular body can maintain its predetermined outer diameter. Thus, the productivity of the transfer roller 1 is improved.

The shaft 3 may be inserted into and fixed to the through-hole 2 at any time between the cutting of the tubular body 7 and the polishing of the tubular body 7.

However, the tubular body is preferably secondarily crosslinked and polished with the shaft 3 inserted in the through-hole 2 thereof after the cutting. This prevents the warpage and the deformation of the tubular body 7 of the transfer roller 1 which may otherwise occur due to the expansion and the contraction of the tubular body 7 during the secondary crosslinking. Further, the tubular body may be polished while being rotated about the shaft 3. This improves the polishing process efficiency, and suppresses the deflection of the outer peripheral surface 4.

Where the outer diameter of the shaft 3 is greater than the inner diameter of the through-hole 2, as described above, the shaft 3 may be pressed into the through-hole 2. Alternatively, the shaft 3 may be inserted into the tubular body 7 before the secondary crosslinking, and fixed to the tubular body 7 with an electrically conductive thermosetting adhesive agent.

In the latter case, the thermosetting adhesive agent is cured by the heating in the oven during the secondary crosslinking, whereby the shaft 3 is electrically connected to and mechanically fixed to the tubular body 7 of the transfer roller 1.

In the former case, the electrical connection and the mechanical fixing are achieved upon the insertion of the shaft 3.

### <Roller Resistance>

The transfer roller 1 preferably has a roller resistance of not greater than 10¹⁰Ω, particularly preferably not greater than 10⁹Ω, as measured at an application voltage of 1000V in an ordinary temperature and ordinary humidity environment at a temperature of 23±1° C. at a relative humidity of 55±1%.

FIG. 3 is a diagram for explaining how to measure the roller resistance of the transfer roller 1.

In the present invention, the roller resistance is expressed as a value determined by a measurement method to be described below with reference to FIGS. 1 and 3.

An aluminum drum 12 rotatable at a constant rotation speed is prepared, and the outer peripheral surface 4 of the transfer roller 1 to be subjected to the measurement of the roller resistance is brought into abutment against an outer peripheral surface 13 of the aluminum drum 12 from above.

A DC power source 14 and a resistor 15 are connected in series between the shaft 3 of the transfer roller 1 and the aluminum drum 12 to provide a measurement circuit 16. The DC power source 14 is connected to the shaft 3 at its negative terminal, and connected to the resistor 15 at its positive terminal. The resistor 15 has a resistance r of 100 Ω.

Subsequently, a load F of 500 g is applied to opposite end portions of the shaft 3 to bring the transfer roller 1 into press contact with the aluminum drum 12 and, in this state, a detection voltage V applied to the resistor 15 is measured with an application voltage E of DC 1000 V applied from the DC power source 14 between the shaft 3 and the aluminum drum 12 while rotating the aluminum drum 12 (at a rotation speed of 30 rpm).

The roller resistance of the transfer roller 1 is basically calculated from the following expression (i′) based on the measured detection voltage V and the application voltage E (=1000 V):

R=r×E/(V−r) (i′)

However, the term (−r) in the denominator of the expression (i′) is negligible, so that the roller resistance of the transfer roller 1 is expressed as a value calculated from the following expression (i) in the present invention:

R=r×E/V (i)

<Rubber Hardness>

The transfer roller 1 preferably has a rubber hardness of not lower than 25 degrees and not higher than 40 degrees as measured in ASKER-C hardness with a load of 500 gf (≈4.9 N) in an ordinary temperature and ordinary humidity environment at a temperature of 23±1° C. at a relative humidity of 55±1% by a measurement method specified by the Society of Rubber Industry Standards SRIS 0101 “Physical Test Methods for Expanded Rubber.”

A soft transfer roller having a rubber hardness less than the aforementioned range has insufficient strength, and fails to provide a predetermined nip pressure in press contact with the photoreceptor body. This may reduce the toner transfer efficiency or result in early abrasion.

A hard transfer roller having a rubber hardness higher than the aforementioned range has insufficient flexibility, and fails to provide a sufficiently great nip width in press contact with the photoreceptor body. This may reduce the toner transfer efficiency or result in damage to the photoreceptor body.

Where the rubber hardness of the transfer roller is within the aforementioned range, in contrast, the transfer roller can be kept in press contact with the photoreceptor body with a proper nip pressure and with a proper nip width, thereby preventing the reduction intoner transfer efficiency without the early abrasion and the damage to the photoreceptor body.

### <Other Characteristic Properties>

The transfer roller 1 can be controlled so as to have a predetermined compression set and a predetermined dielectric dissipation factor.

In order to control the compression set, the ASKER-C hardness, the roller resistance and the dielectric dissipation factor of the transfer roller 1, for example, the types and the amounts of the ingredients of the electrically conductive rubber composition may be properly determined.

### <<Image Forming Apparatus>>

An image forming apparatus according to the present invention incorporates the inventive transfer roller. Examples of the inventive image forming apparatus include various electrophotographic image forming apparatuses such as laser printers, electrostatic copying machines, plain paper facsimile machines and printer-copier-facsimile multifunction machines.

### EXAMPLES

### Example 1

### Preparation of Electrically Conductive Rubber Composition

A rubber component was prepared by blending 20 parts by mass of an ECO (HYDRIN (registered trade name) T3108 available from Zeon Corporation), 10 parts by mass of an EPDM (ESPRENE (registered trade name) 505A available from Sumitomo Chemical Co., Ltd) and 70 parts by mass of an SBR (non-oil-extension type, JSR1502 available from JSR Co., Ltd.)

An electrically conductive rubber composition was prepared by blending ingredients shown below in Table 1 with 100 parts by mass of the overall rubber component, and kneading the resulting mixture by means of a Banbury mixer.

TABLE 1

| Ingredients | Parts by mass |
|---|---|
| Filler | 10 |
| Foaming agent | 4 |
| Acid accepting agent | 1 |
| Crosslinking agent | 1.6 |
| Accelerating agent DM | 1.6 |
| Accelerating agent TS | 2 |

The ingredients shown in Table 1 are as follows. The amounts (parts by mass) of the ingredients shown in Table 1 are based on 100 parts by mass of the overall rubber component.

Filler: Carbon black HAF (SEAST 3 (trade name) available from Tokai Carbon Co., Ltd.)
Foaming agent: Smaller-diameter ADCA foaming agent (CELLMIC (registered trade name) C-1 available form Sankyo Kasei Co., Ltd. and having an average particle diameter of 8 to 11 μm)
Acid accepting agent: Hydrotalcites (DHT-4A-2 available from Kyowa Chemical Industry Co., Ltd.)
Crosslinking agent: Sulfur powder (available from Tsurumi Chemical Industry Co., Ltd.)
Accelerating agent DM: Di-2-benzothiazyl disulfide (SUNSINE MBTS (trade name) available from Shandong Shanxian Chemical Co., Ltd.)
Accelerating agent TS: Tetramethylthiuram disulfide (SANCELER (registered trade name) TS available from Sanshin Chemical Industry Co., Ltd.) (Production of Transfer Roller)

The electrically conductive rubber composition thus prepared was fed into an extruder 6, and extruded into an elongated tubular body having an outer diameter of 10 mm and an inner diameter of 3.0 mm by the extruder. The extruded tubular body 7 was continuously fed out in an elongated state without cutting to be continuously passed through the continuous crosslinking apparatus 5 including the microwave crosslinking device 8 and the hot air crosslinking device 9, whereby the rubber composition of the tubular body was continuously foamed and crosslinked. Then, the resulting tubular body was passed through cooling water to be continuously cooled.

The microwave crosslinking device 8 had an output of 6 to 12 kW and an internal control temperature of 150° C. to 250° C. The hot air crosslinking device 9 had an internal control temperature of 150° C. to 250° C. and an effective heating chamber length of 8 m.

The foamed tubular body 7 had an outer diameter of about 15 mm.

In turn, the tubular body 7 was cut to a predetermined length. The resulting tubular body was fitted around a shaft 3 having an outer diameter of 5 mm and an outer peripheral surface to which an electrically conductive thermosetting adhesive agent was applied, and heated at 160° C. for 60 minutes in an oven, whereby the tubular body 7 was secondarily crosslinked and the thermosetting adhesive agent was cured. Thus, the tubular body 7 was electrically connected to and mechanically fixed to the shaft 3.

Opposite end portions of the tubular body 7 were cut. The tubular body 7 was allowed to stand still in an ordinary temperature and ordinary humidity environment at a temperature of 23±1° C. at a relative humidity of 55±1% for 12 hours after being taken out of the oven, and then the outer peripheral surface 4 of the tubular body 7 was polished by a traverse polishing process utilizing a cylindrical polisher to be thereby finished as having an outer diameter of 12.5 mm (with a tolerance of ±0.1 mm). Thus, a transfer roller 1 was produced.

### Example 2

An electrically conductive rubber composition was prepared in substantially the same manner as in Example 1, except that a smaller-diameter ADCA foaming agent (CELLMIC CE available from Sankyo Kasei Co., Ltd.) having an average particle diameter of 6 to 7 μm was blended as the foaming agent in the same proportion. Then, a transfer roller 1 was produced by using the electrically conductive rubber composition thus prepared.

### Example 3

An electrically conductive rubber composition was prepared in substantially the same manner as in Example 1, except that a smaller-diameter ADCA foaming agent (CELLMIC C-2 available from Sankyo Kasei Co., Ltd.) having an average particle diameter of 3 to 5 μm was blended as the foaming agent in the same proportion. Then, a transfer roller 1 was produced by using the electrically conductive rubber composition thus prepared.

### Comparative Example 1

An electrically conductive rubber composition was prepared in substantially the same manner as in Example 1, except that an ADCA foaming agent of an ordinary particle size (CELLMIC C-191 available from Sankyo Kasei Co., Ltd.) having an average particle diameter of 15 to 20 μm was blended as the foaming agent in the same proportion. Then, a transfer roller 1 was produced by using the electrically conductive rubber composition thus prepared.

### Examples 4 and 5 and Comparative Examples 2 and 3

Electrically conductive rubber compositions were prepared in substantially the same manner as in Example 1, except that the smaller-diameter ADCA foaming agent (CELLMIC C-2 available from Sankyo Kasei Co., Ltd. and having an average particle diameter of 3 to 5 μm) was blended in proportions of 0.1 part by mass (Comparative Example 2), 0.5 parts by mass (Example 4), 8 parts by mass (Example 5) and 8.5 parts by mass (Comparative Example 3) based on 100 parts by mass of the overall rubber component. Then, transfer rollers 1 were respectively produced by using the electrically conductive rubber compositions thus prepared.

### Example 6

An electrically conductive rubber composition was prepared in substantially the same manner as in Example 3, except that the rubber component was prepared by blending 20 parts by mass of the ECO, 10 parts by mass of the EPDM and 40 parts by mass of the SBR (as used in Example 1) and 30 parts by mass of an NBR (non-oil-extension and lower-acrylonitrile-content type NBR JSR N250SL available from JSR Co., Ltd. and having an acrylonitrile content of 20%). Then, a transfer roller 1 was produced by using the electrically conductive rubber composition thus prepared.

<Evaluation for Change in Outer Diameter after Polishing>

The outer diameter φ1 (mm) of each of the transfer rollers 1 of Examples and Comparative examples was measured immediately after the polishing. After the transfer rollers 1 were allowed to stand still in an ordinary temperature and ordinary humidity environment at a temperature of 23±1° C. at a relative humidity of 55±1% for 24 hours, the outer diameter φ2 (mm) of each of the transfer rollers 1 of Examples and Comparative Examples was measured again. A difference Δφ=φ2−φ1 between the outer diameters measured before and after the transfer roller 1 was allowed to stand still was calculated. A transfer roller having a smaller outer diameter change with an outer diameter difference Δφ (mm) of less than 0.05 mm was rated as acceptable (∘), and a transfer roller having a greater outer diameter change with an outer diameter difference Δφ(mm) of greater than 0.05 mm was rated as unacceptable (x).

<Measurement of Roller Resistance>

The roller resistance of each of the transfer rollers 1 produced in Examples and Comparative Examples was measured in an ordinary temperature and ordinary humidity environment at a temperature of 23±1° C. at a relative humidity of 55±1% by the measurement method previously described with reference to FIG. 3. In Tables 2 and 3, the roller resistance R calculated from the aforementioned expression (i) is expressed as log R.

### <Evaluation for Rubber Hardness>

The ASKER-C hardness of each of the transfer rollers 1 produced in Examples and Comparative Examples was measured in an ordinary temperature and ordinary humidity environment at a temperature of 23±1° C. at a relative humidity of 55±1% by the measurement method previously described. A transfer roller having an ASKER-C hardness falling within a range of not less than 25 degrees and not greater than 40 degrees was rated as acceptable (∘), and a transfer roller having an ASKER-C hardness falling outside this range was rated as unacceptable (x).

The results are shown in Tables 2 and 3.

TABLE 2

| | | | | | |
|---|---|---|---|---|---|
| Example 1 | Example 2 | Example 3 | Example 4 | Example 5 | Example 6 |

Ingredients

| | | | | | | | |
|---|---|---|---|---|---|---|---|
| ECO | parts by mass | 20 | 20 | 20 | 20 | 20 | 20 |
| EPDM | parts by mass | 10 | 10 | 10 | 10 | 10 | 10 |
| SBR | parts by mass | 70 | 70 | 70 | 70 | 70 | 40 |
| NBR | parts by mass | — | — | — | — | — | 30 |
| ADCA | Average particle diameter (μm) | 8-11 | 6-7 | 3-5 | 3-5 | 3-5 | 3-5 |
| | parts by mass | 4 | 4 | 4 | 0.5 | 8 | 4 |

Evaluation

| | | | | | | | |
|---|---|---|---|---|---|---|---|
| Outer diameter change | Evaluation | ∘ | ∘ | ∘ | ∘ | ∘ | ∘ |
| Roller resistance | log R | 7.68 | 7.70 | 7.80 | 7.62 | 7.70 | 7.73 |
| Asker-C hardness | Value (degrees) | 35 | 36 | 35 | 39 | 26 | 33 |
| | Evaluation | ∘ | ∘ | ∘ | ∘ | ∘ | ∘ |

TABLE 3

| | | |
|---|---|---|
| Compar- | Compar- | compar- |
| ative | ative | ative |
| Example 1 | Example 2 | Example 3 |

Ingredients

| | | | | |
|---|---|---|---|---|
| ECO | parts by mass | 20 | 20 | 20 |
| EPDM | parts by mass | 10 | 10 | 10 |
| SBR | parts by mass | 70 | 70 | 70 |
| NBR | parts by mass | — | — | — |
| ADCA | Average particle | 15-20 | 3-5 | 3-5 |
| | diameter (μm) | | | |
| | parts by mass | 4 | 0.1 | 8.5 |

Evaluation

| | | | | |
|---|---|---|---|---|
| Outer diameter | Evaluation | x | ∘ | ∘ |
| change | | | | |
| Roller resistance | log R | 7.56 | 7.58 | 7.79 |
| Asker-C | Value (degrees) | 34 | 42 | 24 |
| hardness | Evaluation | ∘ | x | x |

The results for Comparative Example 1 in Table 3 indicate that, where a greater-diameter ADCA foaming agent having an average particle diameter of greater than 11 μm is used as the foaming agent, a tubular body polished in a shorter period of time after the secondary crosslinking and the cooling is liable to be significantly expanded due to the aforementioned mechanism and, therefore, the transfer roller 1 cannot be produced at higher productivity.

In contrast, the results for Examples 1 to 6 in Table 2 indicate that, where a smaller-diameter ADCA foaming agent having an average particle diameter of not less than 3 μm and not greater than 11 μm is used, a tubular body polished in a shorter period of time after the secondary crosslinking and the cooling is prevented from being significantly expanded and, therefore, the transfer roller 1 can be produced at higher productivity.

The results for Examples 3 to 5 and Comparative Examples 2 and 3 in Tables 2 and 3 indicate that the proportion of the smaller-diameter ADCA foaming agent should be not less than 0.5 parts by mass and not greater than 8 parts by mass based on 100 parts by mass of the overall rubber component in order to impart the transfer roller 1 with an ASKER-C hardness of not less than 25 degrees and not greater than 40 degrees to ensure that the transfer roller 1 can be kept in contact with the photoreceptor body with a proper nip pressure and a proper nip width while preventing the reduction in toner transfer efficiency without the early abrasion thereof and the damage to the photoreceptor body.

Further, the results for Examples 3 and 6 in Table 2 indicate that, where the rubber component includes an NBR as a polar rubber in addition to the three types of rubbers (i.e., an ECO, an SBR and an EPDM), the roller resistance of the transfer roller can be finely controlled.

This application corresponds to Japanese Patent Application No. 2013-162623 filed in the Japan Patent Office on Aug. 5, 2013, the disclosure of which is incorporated herein by reference in its entirety.

What is claimed is:

1. An electrically conductive rubber composition which can be foamed and crosslinked by means of a continuous crosslinking apparatus including a microwave crosslinking device and a hot air crosslinking device, the electrically conductive rubber composition comprising:
a rubber component including at least a styrene butadiene rubber, an ethylene propylene diene rubber and an epichlorohydrin rubber;
a crosslinking component for crosslinking the rubber component; and
a foaming component for foaming the rubber component;
wherein the foaming component comprises an azodicarbonamide foaming agent having an average particle diameter of not less than 3 μm and not greater than 11 μm in a proportion of not less than 0.5 parts by mass and not greater than 8 parts by mass based on 100 parts by mass of the overall rubber component.

2. The electrically conductive rubber composition according to claim 1, wherein the rubber component comprises at least one polar rubber selected from the group consisting of an acrylonitrile butadiene rubber, a chloroprene rubber, a butadiene rubber and an acryl rubber.

3. A transfer roller formed from the electrically conductive rubber composition according to claim 1, and produced by extruding the electrically conductive rubber composition into a tubular body and continuously foaming and crosslinking the extruded rubber composition by means of a continuous crosslinking apparatus including a microwave crosslinking device and a hot air crosslinking device.

4. A transfer roller formed from the electrically conductive rubber composition according to claim 2, and produced by extruding the electrically conductive rubber composition into a tubular body and continuously foaming and crosslinking the extruded rubber composition by means of a continuous crosslinking apparatus including a microwave crosslinking device and a hot air crosslinking device.

5. An image forming apparatus comprising the transfer roller according to claim 3.

6. An image forming apparatus comprising the transfer roller according to claim 4.
